(19) United States
(12) Patent Application Publication
(10) Pub. No.: US 2002/0174132 A1
(43) Pub. Date: Nov. 21, 2002

(54) Method and system for detecting unauthorized trademark use on the internet

(75) Inventor: Noah Silverman, New York, NY (US)

Correspondence Address: Frank Chau, F. CHAU & ASSOCIATES, LLP, Suite 501, 1900 Hempstead Turnpike, East Meadow, NY, 11554, US

(73) Assignee: ALLRESEARCH, INC.

(21) Appl. No.: 09/849,290

(22) Filed: May 4, 2001

(51) Int. Cl. G06F 7/00

(52) U.S. Cl. 707/104.1

(57) ABSTRACT

A method for detecting unauthorized trademark use on the Internet searches the Internet to locate instances of a trademark. Uniform Resource Locators (URLs) corresponding to the instances of the trademark are identified. Any of the URLs that are pre-authorized to use the trademark are removed from further consideration. Each of the URLs and pre-specified information corresponding thereto are stored in a database. A report is displayed to a user. The report includes a page that lists at least some international trademark classes for which unauthorized use of the trademark has been detected with respect to the URLs and findings associated therewith. The findings including at least some of the pre-specified information. The method may generate at least one score for each of web sites respectively corresponding to the URLs, based on at least one of a probabilistic and a deterministic method applied to at least one pre-defined class profile.

### 1. TECHNICAL FIELD

The present invention relates generally to protecting intellectual property rights and, in particular, to a method and system for detecting unauthorized trademark use on the Internet.

### 2. BACKGROUND DESCRIPTION

Current “trademark searching” services are limited to searching databases of registrations and registrants at the federal or state level. Additionally, services exist to check for the presence of domain names (either national or international) which may conflict with a client's trademark.

A rudimentary search of Internet content for a client's trademark is known to be provided by MARKMONITOR.COM. However, they do not provide any scoring relating to pre-defined criteria such as whether a site is commercial or offensive. Further, they do not provide the client a way to supply a list of “authorized sources”. Moreover, they do not provide organization of trademarks into industry classes.

Therefore, there is a need for a service which automates the searching on Internet content, and then adds coherence by filtering, classifying, and organizing the data in a way meaningful to the trademark registrant.

### SUMMARY OF THE INVENTION

The problems stated above, as well as other related problems of the prior art, are solved by the present invention, a method and system for detecting unauthorized trademark use on the Internet.

According to an aspect of the invention, there is provided a method for detecting unauthorized trademark use on the Internet. The method includes the step of searching the Internet to locate instances of a predetermined trademark.

Uniform Resource Locators (URLs) corresponding to the instances of the predetermined trademark are identified. Any of the URLs that are pre-authorized to use the predetermined trademark are removed from further consideration. Each of the URLs and pre-specified information corresponding thereto are stored in a database. A report is displayed to a user. The report includes a page that lists at least some international trademark classes for which unauthorized use of the predetermined trademark has been detected with respect to the URLs and findings associated therewith. The findings including at least some of the pre-specified information.

According to another aspect of the invention, the method further includes the step of generating at least one score for each of web sites respectively corresponding to the URLs, based on at least one of a probabilistic and a deterministic method applied to at least one pre-defined class profile. The at least one score pertains to pre-defined parameters corresponding to the unauthorized trademark use.

According to yet another aspect of the invention, the at least one pre-defined class profile includes a class-based commercial profile and the at least one score for each of the web sites indicates to what degree, if any, each of the web sites are commercial.

According to still yet another aspect of the invention, the at least one pre-defined class profile includes a class-based offensive profile and the at least one score for each of the web sites indicates to what degree, if any, each of the web sites are offensive.

According to a further aspect of the invention, the at least one pre-defined class profile includes a class-based international trademark class profile and the at least one score for each of the web sites indicates to what degree, if any, each of the web sites fit into each of international trademark classes in a pre-defined set of international trademark classes.

According to an additional aspect of the invention, the generating step is based on a Bayesian probabilistic.

According to a further additional aspect of the invention, the generating step is based on word frequency.

According to a still further additional aspect of the invention, the generating step uses a vector machine.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a system 100 for detecting unauthorized trademark use on the Internet, according to an illustrative embodiment of the present invention; and

FIG. 2 is a flow diagram illustrating a method 200 for detecting unauthorized trademark use on the Internet, according to an illustrative embodiment of the present invention.

### DETAILED DESCRIPTION OF PREFERRED EMBODIMENTS

The present invention is directed to a method and system for detecting unauthorized trademark use on the Internet. It is to be understood that the present invention may be implemented in various forms of hardware, software, firmware, special purpose processors, or a combination thereof. Preferably, the present invention is implemented as a combination of both hardware and software, the software being an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

It is to be further understood that, because some of the constituent system components depicted in the accompanying Figures may be implemented in software, the actual connections between the system components may differ depending upon the manner in which the present invention is programmed. Given the teachings herein, one of ordinary skill in the related art will be able to contemplate these and similar implementations or configurations of the present invention.

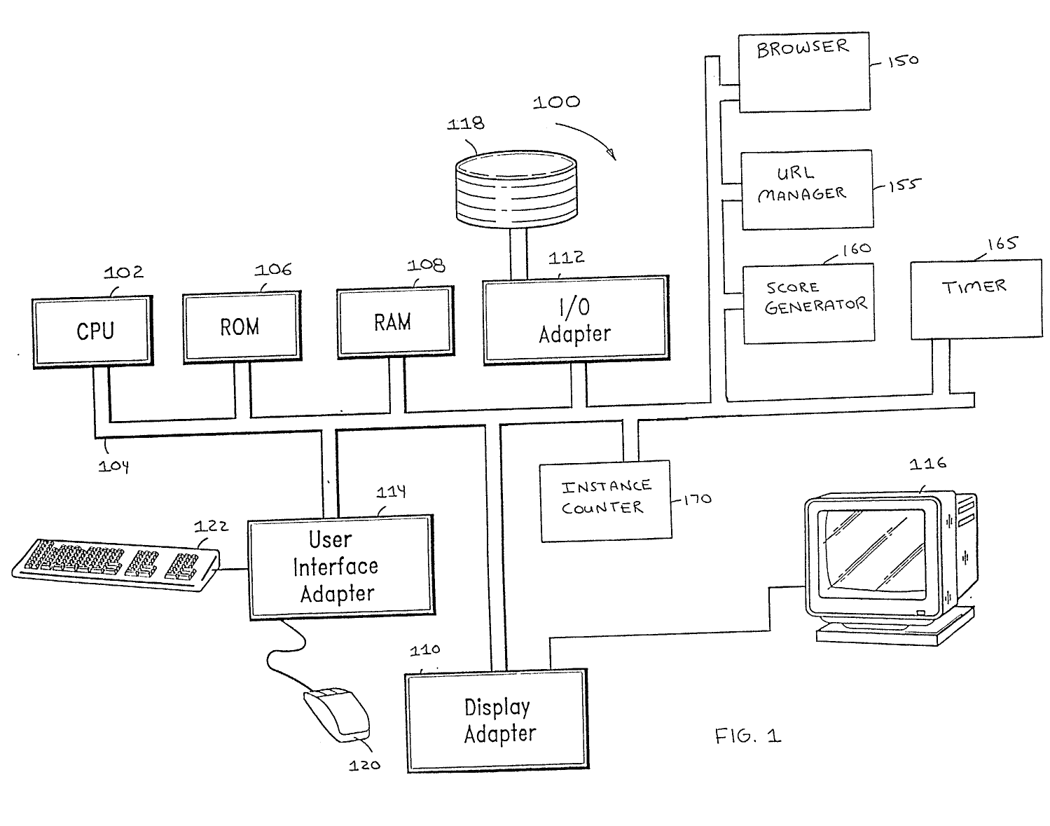

FIG. 1 is a block diagram of a system 100 for detecting unauthorized trademark use on the Internet, according to an illustrative embodiment of the present invention. The system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A mouse 120 and keyboard 122 are operatively coupled to the system bus 104 by the user interface adapter 114. The mouse 120 and keyboard 122 may be used to input/output information to/from the system 100.

A browser 150, a uniform resource locator (URL) manager 155, a score generator 160, a timer 165, and a trademark instance counter 170 are operatively coupled to the system bus 104.

The browser 150 interfaces with the Internet to, e.g., access search engines to search for instances of a predetermined trademark. The browser 150 may display reports and other information relating to unauthorized trademark use on the Internet. Alternatively, some or all of the reports and other information may be e-mail, or otherwise provided, to a user in a pre-specified format corresponding to e.g., a word processor.

The URL manager 155 manages one or more URLs corresponding to search results obtained using the browser 150 as well as URLs obtained without the browser 150 (e.g., URLs comprised in a user-specified list of “authorized locations”) The URL manager performs a variety of functions with respect to URLs to obtain one or more pre-specified objectives of the present invention as defined below.

The score generator 160 generates one or more scores for web sites respectively corresponding to URLs (e.g., for each web site corresponding to each URL specified in the search results obtained using the browser). The one or more scores may be generated based on probabilistic and/or deterministic methods being applied to one or more pre-defined class profiles. The one or more scores pertain to pre-defined parameters corresponding to unauthorized trademark use, as defined in various embodiments of the present invention.

The timer 165 generates time stamps relating to the performance of various functions corresponding to the detection of unauthorized trademark use.

The trademark instance counter 170 identifies and counts instances of the predetermined trademark in various portions of a web page such as, for example, a title portion, a body text portion, a hyper-text markup language (HTML) portion, meta-tags, and so forth.

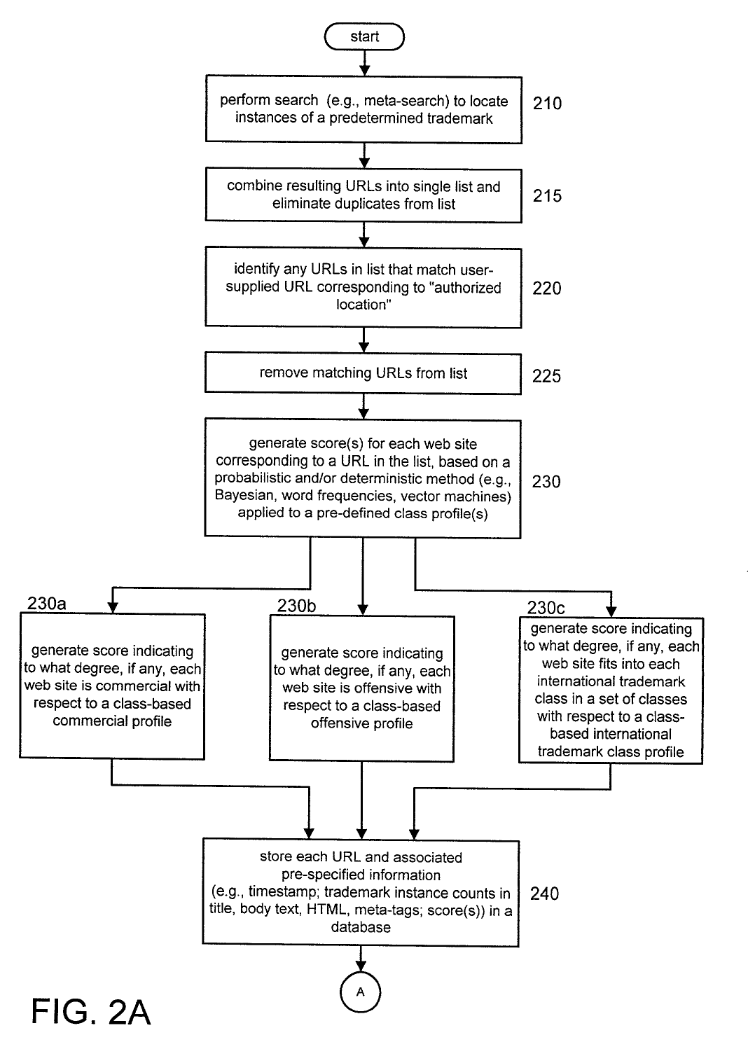

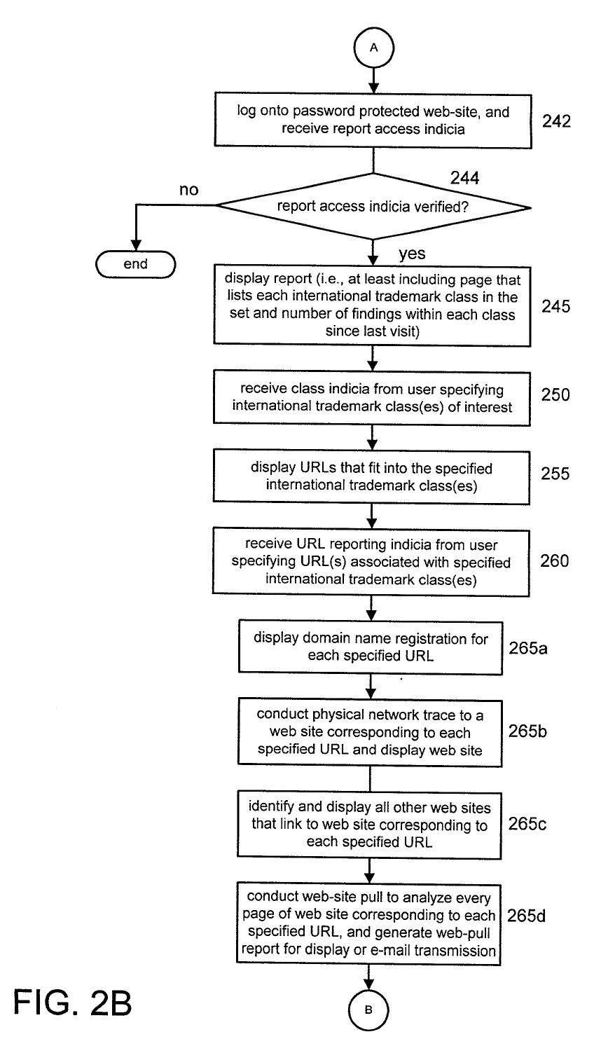

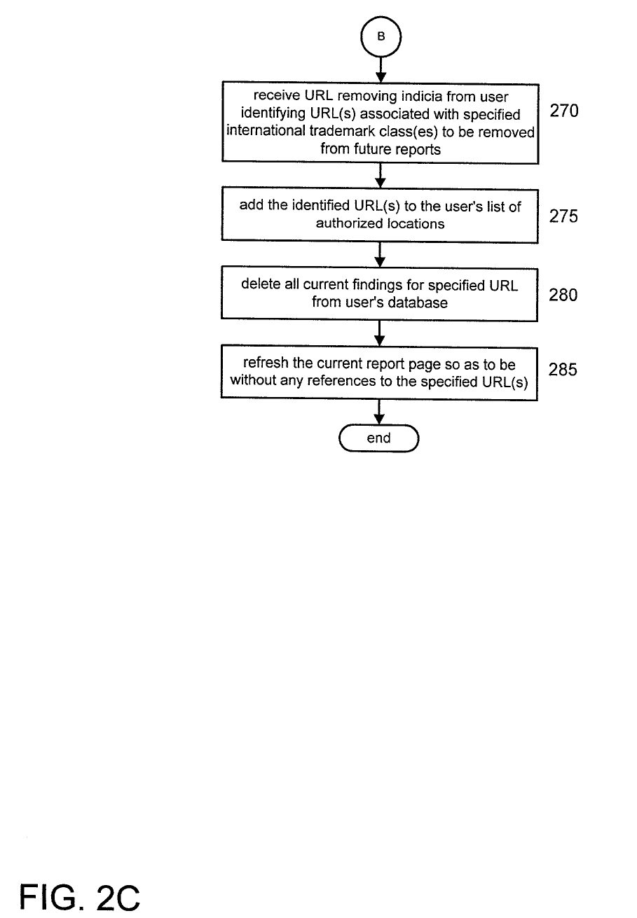

FIG. 2 is a flow diagram illustrating a method 200 for detecting unauthorized trademark use on the Internet, according to an illustrative embodiment of the present invention.

A search is performed to locate instances of a predetermined trademark (step 210). Preferably, the search is a meta-search of all major search engines. Step 210 may be performed using the browser 150, which would interface with the Internet to access one or more search engines. Any resulting Uniform Resource Locators (URLs) from the meta-search are combined into a single, meta-search result list and any duplicate URLs are eliminated from the list (step 215).

Identify any of the URLs in the meta-search result list that match a URL in a user-supplied list of URLs corresponding to “authorized locations” by comparing each of the URLs in the meta-search result list to the user-supplied list of URLs (step 220). If any matching URLs exist, the matching URLs are removed from the meta-search result list (step 225). Steps 215, 220, and 225 may be performed by the URL manager 155.

The remaining URLs in the meta-search result list (i.e., those remaining after steps 215, 220, and 225) are processed to determine at least one score for each of the web sites that respectively correspond to the URLs, based on a probabilistic method and/or a deterministic method being applied to one or more pre-defined class profiles (step 230). The one or more scores pertain to pre-defined parameters corresponding to unauthorized trademark use. Step 230 may include the use of, for example, Bayesian probabilistics, word frequencies, and/or vector machines. Of course, other probabilistic and deterministic approaches may be used, while maintaining the spirit and scope of the present invention.

In one embodiment of the present invention, the one or more predefined class profiles include mathematical models that represent pre-defined parameters corresponding to unauthorized trademark use on the Internet. The mathematical models may include pre-specified keywords and phrases for a given parameter(s) and, optionally, corresponding weights for the keywords and phrases. Of course, the present invention is not limited to the preceding representations of class models, and various other representations may be employed while maintaining the spirit and scope of the present invention.

As an example of a class profile, consider a class-based “commercial” profile used to determine to what degree, if any, the web sites corresponding to the URLs remaining after step 225 are “commercial” web sites. Such a profile would consist of keywords and phrases that are “commercial” in nature, such as, for example, “sale”, “catalog”, “price”, “retail price”, “buy now”, and so forth. In one illustrative embodiment of the present invention, weights are assigned to the keywords and phrases to indicate a relative importance or relevance with respect to the corresponding parameter (e.g., whether web site is commercial). For example, in the illustrative list of keywords and phrases provided above, “buy now” would likely have a very high, if not the highest, weight.

In one illustrative embodiment of the present invention, the keywords and phrases included in the class profiles are represented by vectors. Any words (or a pre-specified subset thereof) used at a web-site corresponding to the URLs remaining after step 225 would be transformed to vectors and distance measurements would be obtained between the vectors for the words used at the web-site and the vectors for the keywords and phrases included in the class profiles. Such distance measurements may include, for example, Euclidian distance, angular distance (e.g., cosine, sine, tangent, etc.), and so forth. Of course, the invention is not limited to the preceding distance measurements and other measurements may be employed therewith.

To further illustrate the invention, various exemplary scores will now be described with respect to step 230 of FIG. 2. Given the teachings of the present invention provided herein, one of ordinary skill in the related art will contemplate these and various other relevant scores with respect to detecting unauthorized trademark use on the Internet, while maintaining the spirit and scope of the present invention.

The URLs in the meta-search result list are processed to determine to what degree, if any, the web sites are “commercial” web sites, with respect to a class-based “commercial” profile, for example, as described above (step 230a). Step 230a includes outputting a resultant “commercial” score for each of the web sites, based on a result of the determination.

The URLs in the meta-search result list are then processed to determine to what degree, if any, the web sites are “offensive”, with respect to a class-based “offensive” profile (step 230b). Step 230b includes outputting a resultant “offensive” score for each of the web sites, based on a result of the determination.

With respect to the illustrate representation for class profiles described above (i.e., various keywords and phrases and, optionally, weights assigned thereto), the keywords and phrases may consist of, for example, profanities, with relative weights optionally assigned thereto. Of course, other representations for the class-based “offensive” profile may be employed in accordance with the present invention.

The URLs in the meta-search result list are then processed to determine to what degree, if any, the web sites fit into each international trademark class in a pre-defined set of international trademark classes, with respect to a class-based “international trademark class” profile (step 230c). Step 230c includes outputting a resultant “trademark class” score for each trademark class for each of the web sites, based on a result of the determination. Of course, the pre-defined set of international trademark classes may include all international trademark classes or a subset thereof.

With respect to the illustrate representation for class profiles described above (i.e., various keywords and phrases and, optionally, weights assigned thereto), the keywords and phrases may consist of, for example, the exacts words used in the international trademark classes (e.g., for class 4, “lubricants” and “fuels”), with relative weights optionally assigned thereto.

It is to be appreciated that some, none, or all of steps 230a, 230b, and 230c may be substituted with other steps for determining other scores relating to the detection of unauthorized trademark use on the Internet, while maintaining the spirit and scope of the present invention. Step 230, including steps 230a, 230b, and 230c, may be performed by the score generator 160.

Each of the URLs in the meta-search result list is then stored in a database (e.g., in the RAM 108 and/or the disk storage device 118) (step 240), with at least some of the following, pre-specified information: (a) a time-stamp; (b) a count of the instances of the predetermined trademark that occur in the title of a corresponding web-page(s); (c) a count of the instances of the predetermined trademark that occur in the body text of a corresponding web-page(s); (d) a count of the instances of the predetermined trademark that occur in the HTML of a corresponding web-page(s); (e) a count of the instances of the predetermined trademark that occur in the meta tags of a corresponding web-page(s); (f) the commercial score indicating to what degree, if any, the corresponding site is a commercial site; (g) the offensive score indicating to what degree, if any, the corresponding site is offensive; and (h) for each international trademark class in the pre-defined set of international trademark classes, the trademark class score indicating to what degree, if any, the corresponding site fits into that international trademark class. Item a of step 240 may be obtained/determined by the timer 165, items b through e by the trademark instance counter, and items f through h by the score generator 160. It is to be appreciated that items a through h of step 240 are pre-specified (i.e, pre-selected for acquisition), and substitutions of some, none, or all of these items may be readily implemented by one of ordinary skill in the related art while maintaining the spirit and scope of the present invention.

A password protected portion of a reporting web-site is logged onto by the user (using the browser 150) and report access indicia (e.g., password, pin number, and so forth) is received from the user via e.g., the mouse 120 and/or the keyboard 122 (step 242). If the report access indicia is verified, then a corresponding report is displayed to the user on the display device 116 (step 245). The report includes a page that lists each international trademark class in the pre-defined set of international trademark classes and the number of findings within each class since the user's last visit.

Class indicia may be received from a user (via, e.g., the mouse 120 and/or the keyboard 122) that specifies one or more international trademark classes (from among the pre-defined set of international trademark classes) that are of interest to the user (step 250). The URLs that “fit” into the specified one or more international trademark classes are then displayed to the user along with at least some of the associated, pre-specified information for each of those URLs (step 255).

URL reporting indicia may be received from a user (via, e.g., the mouse 120 and/or the keyboard 122) that specifies one or more of the URLs associated with the one or more international trademark classes specified by the user at step 250 (step 260). Any or all of steps 265a through 265d that follow may be performed in response to step 260, as predetermined or dynamically selected by the user. The domain name registration for each specified URL is then displayed to the user on the display device 116 (step 265a). A physical network trace to a web site corresponding to each specified URL may be conducted and the web site then displayed on the display device 116 (step 265b). It is to be appreciated that the physical network trace indicates absolute ownership of the Internet Service Provider (ISP) of the site corresponding to each specified URL, in the event that the domain registration information (display at step 260) has been falsified. All other web sites that link to the site corresponding to each specified URL may be identified and displayed on the display device 116 (step 265c). A “web-site pull” may be conducted which analyzes every page of the site corresponding to each specified URL, resulting in a web-site pull report with a summary page being displayed or e-mailed to the client (step 265d). Given the teachings of the present invention provided herein, one of ordinary skill in the related art will contemplate the information displayed at steps 265a through 265d to be interest to a user as well as various other information pertaining to unauthorized trademark use of the Internet. The various other information may be substituted in place of some, none, or all of the information displayed at steps 265a through 265d, and/or may be used to augment such information, while maintaining the spirit and scope of the present invention.

URL removing indicia may be received from a user (via, e.g., the mouse 120 and/or the keyboard 122) that identifies one or more of the URLs associated with the one or more international trademark classes specified at step 250 to be removed from future reports (step 270). Accordingly, the one or more URLs identified by the URL removing indicia will be added by the URL manager 155 to the user's list of “authorized locations” to skip (step 275). All current findings for the one or more URLs identified by the URL removing indicia are immediately deleted from the user's database (step 280) by the URL manager 155. The current report page is refreshed to be displayed without any references to the one or more URLs identified by the URL removing indicia (step 285).

Although the illustrative embodiments have been described herein with reference to the accompanying drawings, it is to be understood that the present system and method is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for detecting unauthorized trademark use on the Internet, comprising the steps of:
searching the Internet to locate instances of a predetermined trademark;
identifying Uniform Resource Locators (URLs) corresponding to the instances of the predetermined trademark;
removing from further consideration any of the URLs that are pre-authorized to use the predetermined trademark;
storing, in a database, each of the URLs and pre-specified information corresponding thereto; and
displaying a report to a user, the report comprising a page that lists at least some international trademark classes for which unauthorized use of the predetermined trademark has been detected with respect to the URLs and findings associated therewith, the findings including at least some of the pre-specified information.

2. The method according to claim 1, wherein said searching step comprises the step of conducting a meta-search of at least two search engines to locate the instances of the predetermined trademark.

3. The method according to claim 1, further comprising the step of combining the URLs into a single list.

4. The method according to claim 3, further comprising the step of eliminating from the single list any duplicates of the URLs.

5. The method according to claim 3, further comprising the step of removing from the single list any of the URLs that are pre-authorized.

6. The method according to claim 1, further comprising the step of generating at least one score for each of web sites respectively corresponding to the URLs, based on at least one of a probabilistic and a deterministic method applied to at least one pre-defined class profile, the at least one score pertaining to pre-defined parameters corresponding to the unauthorized trademark use.

7. The method according to claim 6, wherein said generating step is performed prior to said storing step.

8. The method according to claim 7, wherein the pre-specified information at least comprises the at least one score for each of the web sites.

9. The method according to claim 6, wherein the findings comprises the URLs and the at least one score.

10. The method according to claim 6, wherein the at least one pre-defined class profile comprises a class-based commercial profile and the at least one score for each of the web sites indicates to what degree, if any, each of the web sites are commercial.

11. The method according to claim 6, wherein the at least one pre-defined class profile comprises a class-based offensive profile and the at least one score for each of the web sites indicates to what degree, if any, each of the web sites are offensive.

12. The method according to claim 6, wherein the at least one pre-defined class profile comprises a class-based international trademark class profile and the at least one score for each of the web sites indicates to what degree, if any, each of the web sites fit into each of international trademark classes in a pre-defined set of international trademark classes.

13. The method according to claim 1, further comprising the step of generating at least two of a first score, a second score, and a third score for each of web sites respectively corresponding to the URLs, based on at least one of a probabilistic and a deterministic method applied to at least one pre-defined class profile, wherein the first score indicates to what degree, if any, each of the web sites are commercial with respect to a class-based commercial profile, the second score indicates to what degree, if any, each of the web sites are offensive with respect to a class-based offensive profile, and the third score indicates to what degree, if any, each of the web sites fit into each of international trademark classes in a pre-defined set of international trademark classes with respect to a class-based international trademark class profile.

14. The method according to claim 13, wherein said generating step generates all three of the first score, the second score, and the third score for each of the web sites.

15. The method according to claim 6, wherein said generating step is based on a Bayesian probabilistic.

16. The method according to claim 6, wherein said generating step is based on word frequency.

17. The method according to claim 6, wherein said generating step uses a vector machine.

18. The method according to claim 6, wherein the at least one pre-defined class profile comprises keywords.

19. The method according to claim 18, wherein the at least one pre-defined class profile comprises weights assigned to the keywords with respect to at least one of importance and relevance to a corresponding class.

20. The method according to claim 1, wherein the pre-specified information further comprises a time stamp.

21. The method according to claim 1, wherein the pre-specified information further comprises a count of the instances in a title portion of each of the web sites.

22. The method according to claim 1, wherein the pre-specified information further comprises a count of the instances in a body text portion of each of the web sites.

23. The method according to claim 1, wherein the pre-specified information further comprises a count of the instances in a hyper-text markup language (HTML) portion of each of the web sites.

24. The method according to claim 1, wherein the pre-specified information further comprises a count of the instances in meta-tags of each of the web sites.

25. The method according to claim 1, wherein the report is displayed to the user in said displaying step only after report access indicia provided by the user has been verified.

26. The method according to claim 1, wherein the findings correspond to a time period subsequent to a last visit to the page by the user.

27. The method according to claim 1, further comprising the step of displaying the URLs that correspond to one or more international trademark classes specified by the user, when the user has specified the one or more international trademark classes from among the at least some international trademark classes.

28. The method according to claim 27, further comprising the step of respectively displaying one or more domain name registrations for one or more of the displayed URLs, when the user has specified the one or more displayed URLs.

29. The method according to claim 27, further comprising the step of respectively displaying web sites corresponding to one or more of the displayed URLs, when the user has specified the one or more displayed URLs.

30. The method according to claim 27, further comprising the step of respectively displaying other web sites linked to web sites corresponding to one or more of the displayed URLs, when the user has specified the one or more displayed URLs.

31. The method according to claim 27, further comprising the step of displaying a web-site pull report corresponding to an analysis of each page of web sites respectively corresponding to one or more of the displayed URLs, when the user has specified the one or more displayed URLs.

32. The method according to claim 31, further comprising the step of e-mailing the web-site pull report to the user, when the user has designated that the web-site pull report is to be provided via e-mail.

33. The method according to claim 1, further comprising the step of storing an indication to remove one or more of the URLs from future reports, when the indication is provided by the user.

34. The method according to claim 33, further comprising the step of removing all current findings from the database for the one or more URLs for which the indication has been provided.

35. The method according to claim 33, further comprising the step of refreshing the report displayed to the user, when the one or more URLs have been removed.

36. The method according to claim 34, further comprising the step of refreshing the report displayed to the user, when the all current findings have been removed.

37. A method for detecting unauthorized trademark use on the Internet, comprising the steps of:
searching the Internet to locate instances of a predetermined trademark;
identifying Uniform Resource Locators (URLs) corresponding to the instances of the predetermined trademark;
removing from further consideration any of the URLs that are pre-authorized to use the predetermined trademark;
generating at least two of a first score, a second score, and a third score for each of web sites respectively corresponding to the URLs, based on at least one of a probabilistic and a deterministic method applied to at least one pre-defined class profile, wherein the first score indicates to what degree, if any, each of the web sites are commercial with respect to a class-based commercial profile, the second score indicates to what degree, if any, each of the web sites are offensive with respect to a class-based offensive profile, and the third score indicates to what degree, if any, each of the web sites fit into each of international trademark classes in a pre-defined set of international trademark classes with respect to a class-based international trademark class profile;
storing, in a database, each of the URLs and pre-specified information corresponding thereto, the pre-specified information at least comprising the at least two of the first score, the second score, and the third score; and
displaying a report to a user, the report comprising a page that lists at least some international trademark classes for which unauthorized use of the predetermined trademark has been detected with respect to the URLs and findings associated therewith, the findings at least comprising the at least two of the first score, the second score, and the third score.

38. A system for detecting unauthorized trademark use on the Internet, comprising:
a browser for interfacing with the Internet to locate instances of a predetermined trademark and to identify Uniform Resource Locators (URLs) corresponding to the instances of the predetermined trademark;
a URL manager for removing from further consideration any of the URLs that are pre-authorized to use the predetermined trademark;
a storage device for storing each of the URLs and pre-specified information corresponding thereto; and
a display device for displaying a report to a user, the report comprising a page that lists at least some international trademark classes for which unauthorized use of the predetermined trademark has been detected with respect to the URLs and findings associated therewith, the findings including at least some of the pre-specified information.

39. The system according to claim 38, wherein said browser interfaces with at least two search engines to conduct a meta-search of the at least two search engines to locate the instances of the predetermined trademark.

40. The system according to claim 38, further a URL manager for combining the URLs into a single list.

41. The system according to claim 40, wherein said URL manager eliminates from the single list any duplicates of the URLs.

42. The system according to claim 40, wherein said URL manager removes from the single list any of the URLs that are pre-authorized.

43. The system according to claim 38, further comprising a score generator for generating at least one score for each of web sites respectively corresponding to the URLs, based on at least one of a probabilistic and a deterministic method applied to at least one pre-defined class profile, the at least one score pertaining to pre-defined parameters corresponding to the unauthorized trademark use.

44. The system according to claim 43, wherein the pre-specified information at least comprises the at least one score for each of the web sites.

45. The system according to claim 43, wherein the findings comprises the URLs and the at least one score.

46. The system according to claim 43, wherein the at least one pre-defined class profile comprises a class-based commercial profile and the at least one score for each of the web sites indicates to what degree, if any, each of the web sites are commercial.

47. The system according to claim 43, wherein the at least one pre-defined class profile is a class-based offensive profile and the at least one score for each of the web sites indicates to what degree, if any, each of the web sites are offensive.

48. The system according to claim 43, wherein the at least one pre-defined class profile is a class-based international trademark class profile and the at least one score for each of the web sites indicates to what degree, if any, each of the web sites fit into each of international trademark classes in a pre-defined set of international trademark classes.

49. The system according to claim 38, further comprising a score generator for generating at least two of a first score, a second score, and a third score for each of web sites respectively corresponding to the URLs, based on at least one of a probabilistic and a deterministic method applied to at least one pre-defined class profile, wherein the first score indicates to what degree, if any, each of the web sites are commercial with respect to a class-based commercial profile, the second score indicates to what degree, if any, each of the web sites are offensive with respect to a class-based offensive profile, and the third score indicates to what degree, if any, each of the web sites fit into each of international trademark classes in a pre-defined set of international trademark classes with respect to a class-based international trademark class profile.

50. The system according to claim 49, wherein said score generator generates all three of the first score, the second score, and the third score for each of the web sites.

51. The system according to claim 43, wherein said generating step is based on a Bayesian probabilistic.

52. The system according to claim 43, wherein at least one of the at least one score is based on word frequency.

53. The system according to claim 43, wherein at least one of the at least one score is based on a vector machine.

54. The system according to claim 43, wherein the at least one pre-defined class profile comprises keywords.

55. The system according to claim 54, wherein the at least one pre-defined class profile comprises weights assigned to the keywords with respect to at least one of importance and relevance to a corresponding class.

56. The system according to claim 38, further comprising a timer for generating a time stamp, wherein the time stamp is comprised in the pre-specified information.

57. The system according to claim 38, further comprising a trademark instance counter for counting a number of the instances in a title portion of each of the web sites, wherein the number of instances in the title portion of each of the web sites is comprised in the pre-specified information.

58. The system according to claim 38, further comprising a trademark instance counter for counting a number of the instances in a body text portion of each of the web sites, wherein the number of instances in the body text portion of each of the web sites is comprised in the pre-specified information.

59. The system according to claim 38, further comprising a trademark instance counter for counting a number of the instances in a hyper-text markup language (HTML) portion of each of the web sites, wherein the number of instances in the HTML portion of each of the web sites is comprised in the pre-specified information.

60. The system according to claim 38, further comprising a trademark instance counter for counting a number of the instances in meta-tags of each of the web sites, wherein the number of instances in the meta-tags of each of the web sites is comprised in the pre-specified information.

61. The system according to claim 38, wherein said display device displays the report to the user only after report access indicia provided by the user has been verified.

62. The system according to claim 38, wherein the findings correspond to a time period subsequent to a last visit to the page by the user.

63. The system according to claim 38, wherein said display device displays the URLs that correspond to one or more international trademark classes specified by the user, when the user has specified the one or more international trademark classes from among the at least some international trademark classes.

64. The system according to claim 63, wherein said display device respectively displays one or more domain name registrations for one or more of the displayed URLs, when the user has specified the one or more displayed URLs.

65. The system according to claim 63, wherein said display device respectively displays web sites corresponding to one or more of the displayed URLs, when the user has specified the one or more displayed URLs.

66. The system according to claim 63, wherein said display device respectively displays other web sites linked to web sites corresponding to one or more of the displayed URLs, when the user has specified the one or more displayed URLs.

67. The system according to claim 63, wherein said display device displays a web-site pull report corresponding to an analysis of each page of web sites respectively corresponding to one or more of the displayed URLs, when the user has specified the one or more displayed URLS.

68. The system according to claim 38, further comprising a memory device for storing an indication to remove one or more of the URLs from future reports, when the indication is provided by the user.

69. The system according to claim 68, further comprising a URL manager for removing all current findings from the database for the one or more URLs for which the indication has been provided.
